(19) United States
(12) Patent Application Publication
(10) Pub. No.: US 2005/0256771 A1
(43) Pub. Date: Nov. 17, 2005

(54) System and method of matching artistic products with their audiences

(76) Inventor: E. Ran Garret, Altadena, CA (US)

Correspondence Address: Kleinberg & Lerner, LLP, Suite 1080, 2049 Century Park East, Los Angeles, CA, 90067, US

(21) Appl. No.: 11/126,897

(22) Filed: May 11, 2005

Related U.S. Application Data
(60) Provisional application No. 60/570,104, filed on May 12, 2004.

(51) Int. Cl. G06F 17/60

(52) U.S. Cl. 705/14; 705/10

(57) ABSTRACT

A system and method of selecting products and services for an audience likely to purchase such products and services utilizes a collection of data reflecting, for individual consumers, a history of purchases, and retention or return of such purchases. For individual consumers, subsets of consumers are created whose tastes correlate positively and negatively with the individual consumer. Lists are created of products for a target consumer based on the likes of the subset positively correlating and the dislikes of the subset negatively correlating. Recommended products are offered with a financial incentive such as a money back guarantee which serves the dual purpose of inducing the purchase as well as providing the purchase and return data needed in the data collection.

### CROSS REFERENCE TO RELATED APPLICATIONS

This is a continuation-in-part of my provisional application for letters patent Ser. No. 60/570,104, filed May 12, 2004.

### STATEMENT REGARDING FEDERALLY SPONSORED RESEARCH/DEVELOPMENT

N/A

### REFERENCE TO MICROFICHE APPENDIX

N/A

### BACKGROUND OF THE INVENTION

1. Field of the Invention

The present invention relates to the use of computer systems to aid in the selection of artistic products and, more particularly, a system and method of matching available artistic endeavors to a receptive audience.

2. Description of the Related Art

Providing recommendations of goods or services to customers using a computer system interfaced with a distributed network utilizing a customer activity history database has been described an claimed in the patent to Stack, U.S. Pat. No. 6,782,370 B1, issued Aug. 24, 2004. The customer activity database represents a collection of data of customer buying history based on the passive collection of purchasing decisions of many customers.

The system and method disclosed by Stack was primarily involved with books, but was considered generally applicable to other goods or services. Stack relied primarily upon the passive collection of purchasing data from not only the individual seeking recommendations, but from all other individuals purchasing the same or similar goods in an attempt to find patterns in likes or preferences.

An artistic product, however, is one whose quality is an entirely subjective assessment. “Artisticness” is a continuum, not a dichotomy. There are subjective elements in the assessment of the quality of nearly every product. Cars and computers, to name but two examples, are not generally considered artistic (except, perhaps, among collectors) but which nonetheless possess subjective and aesthetic elements in their design. But cars and computers also have objective measures of quality (e.g. reliability).

The present invention relates to products whose subjective measures of quality dominate whatever objective measures there may be. Examples of such products include paintings, poems, music, books and motion pictures. Works of non-fiction are on the hairy edge of this definition, but we consider them to fall on the artistic side of the divide for reasons that will shortly become apparent. Successfully selling an artistic product depends on finding an audience for the product, which is to say, finding a person or a group of people whose subjective assessment of the quality of that product is high enough to deem it worth paying for. The larger the audience the greater the potential reward.

As a result, one observes empirically that artistic products fall into one of two categories: art that appeals to large audiences and art that does not. Accordingly, one observes a further distinction between art that is designed to appeal to large audiences and art that is not. The canonical example of designed art is the so-called “Hollywood movie” (which may or may not be made in Hollywood nowadays) which adheres to an extensive list of constraints on style and content designed to imbue the resulting product with broad market appeal.

A similar phenomenon occurs in books, where there are formulas for things like “thrillers”, “bodice rippers”, and “whodunits”, all of which tend to have broad appeal. Of course, just because an artistic product is designed to appeal to a large audience is no guarantee that it will. Conversely, just because a movie is not designed for mass appeal does not necessarily mean it won't have any.

The annals of motion pictures are filled with expensive catastrophic flops like Disney's “Treasure Island” and surprise breakouts like “The Blair Witch Project”. Many artistic products, and movies in particular, never get a chance to reach their audience. This is because movies are expensive to produce and distribute, and so, only a small fraction of the filmed motion pictures ever make it to theatres.

Movies are also expensive from the customer's point of view to “try on for size”. The only way for someone to assess the quality of a movie is to see it, which requires the investment of the price of a ticket (or a DVD) and two hours or so of time. Moreover, if they don't like it, it's too late to do anything about it. Movies are, end to end, a risky business.

In an attempt to mitigate these risks, producers conduct market research, usually in the form of surveys and focus groups. These techniques have two important limitations: first, conducting surveys and focus groups is expensive. Second, the data they provide are unreliable for various reasons. People are notoriously unreliable when it comes to introspecting about their own preferences. Further, many people find the process of filling out surveys and participating in focus groups to be bothersome and intrusive, so the data are subject to a “selection” bias because one can only collect data from those people who willingly provide it.

Consumers likewise attempt to mitigate the risks of paying for a movie by reading reviews or watching previews. But these also have problems. There is no guarantee that a critical review will correlate well with a particular individual's tastes, and seeing a trailer can sometimes spoil the movie viewing experience by giving away important plot points. The upshot is that, despite the best efforts of producers and consumers, the business of making, distributing, and viewing movies and other artistic products remains very much a “crap shoot.”

### SUMMARY OF THE INVENTION

The present invention is a process comprising the following steps:
1. Generate individualized product recommendations (in a manner to be described shortly);
2. Offer a money-back guarantee for products that a customer purchases from his or her list of recommended products;
3. Use a computer database to record the data on which products were accepted by particular customers and which were returned for a refund;
4. Mine the resulting database for predictors of customer preferences; and
5. Use the resulting predictors to generate the next round of product recommendations.

The key to the invention is the combination of two elements: a money-back guarantee and computerized data mining techniques. The money-back guarantee serves a dual purpose. First, it serves the usual business purpose of encouraging purchases by assuming a significant element of risk that would normally be borne by the customer. Second, and more importantly, it is the mechanism by which marketing data is collected. These data are the raw material for the computerized data mining, the results of which guide the product recommendations.

The use of a money-back guarantee as a mechanism for generating marketing data has a number of benefits. It generates marketing data “transparently”, that is, without the customer being overtly aware that this data is being collected. Thus, this method is less intrusive than traditional surveys or focus groups. It inherently produces reliable data on the only metric that matters: whether or not a customer liked a particular product well enough to be willing to pay for it. The data are collected not from a sample group but from the entire customer base. There is no self-selection bias and no problem with inaccurate introspection because the market results are the data, and vice versa.

The resulting combination is a seamless three-way win. Customers can buy artistic products with reduced risk. Because product recommendations are individually tailored based on their previous purchases, future purchases have a high probability of being high-quality by their own personal standards, not by any mass-market standards. All this is achieved without requiring the customer to fill out any intrusive and time-consuming questionnaires.

Accordingly, the object of the present invention to provide a way to better mitigate the risks of distributing and consuming artistic products. Another object of the invention is to provide a reliable way to match artistic products with their audiences in a way that does not require expensive and intrusive surveys or focus groups.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 is a block diagram of a system according to the present invention;

FIG. 2 is a general flow chart for a data mining algorithm; and

FIG. 3 is a flow chart of a specific data mining algorithm suitable for use with the system of FIG. 1.

### DETAILED DESCRIPTION OF THE INVENTION

We will now give a detailed description of the preferred embodiment. It is to be understood that this is just one possible realization of the invention. These details are not intended to be constraining. For the purposes of illustration we will assume that the products being offered are motion pictures recorded on digital video disks. It is to be understood that this method can be applied to any artistic product, including but not limited to books, lithographs, audio recordings, and sculptures. It is also possible to extend the invention to include some products that are not necessarily considered artistic but which may embody style or fashion and therefore be acquired based upon similar subjective values.

These products are offered to customers by any of a number of means, including but not limited to bricks-and-mortar stores, the Internet, or mail-order catalogs. Products may be offered for sale or rent. Certain products are offered to certain customers with a money-back guarantee. The means by which it is decided which products to offer to which customers with this guarantee will be described shortly.

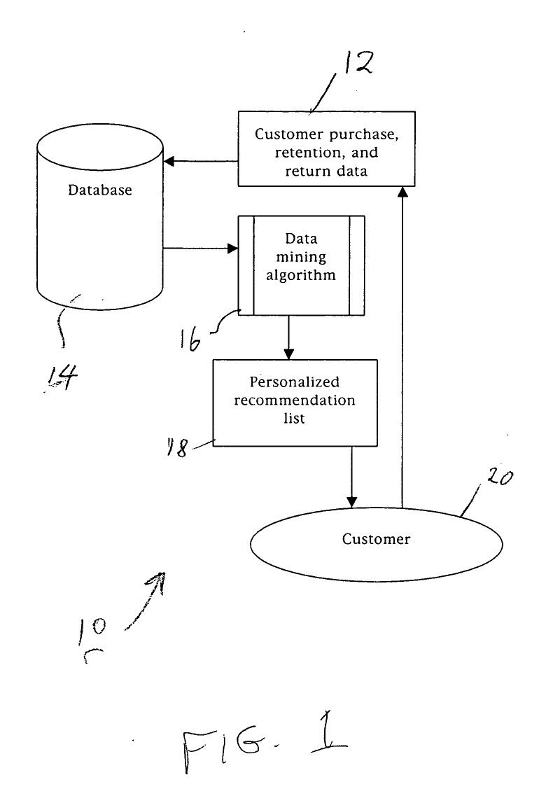

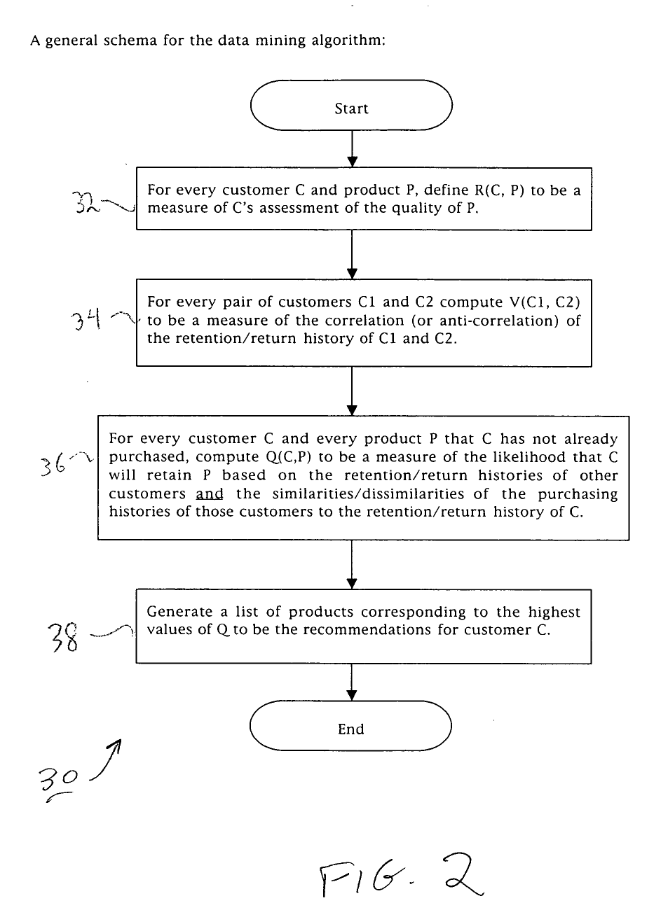

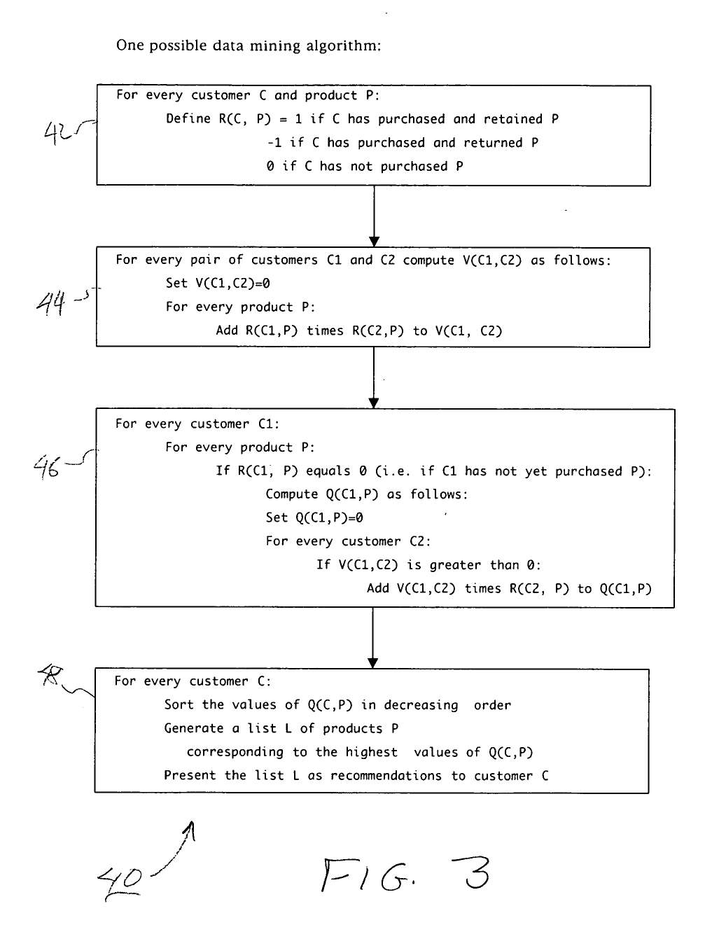

FIG. 1 illustrates a system 10 useful with the present invention. A record of which products are accepted by each customer and which are returned is stored in a first portion 12 of a computer database 14. This database 14 is mined using a computerized data mining algorithm 16 to find predictors for customer preferences. There are many techniques for accomplishing this and will be explained in greater detail in conjunction with FIGS. 2 and 3.

One way to generate predictors is to search for pairs of customers whose record of accepted and returned products is strongly correlated. Intuitively, one could say that these two customers have similar tastes. Therefore, a movie that was seen and accepted by one member of the pair is likely to be accepted by the other member of the pair. Each member of the pair thus serves as a predictor for the other member, and one would recommend to one customer movies that the other had seen and accepted. (Needless to say, one would only recommend movies that the customer had not already seen.)

There are many ways to extend this idea, all of which are well known to those skilled in the art. For example, instead of looking only for correlations, one could also look for anti-correlations. One could generate a complete covariance matrix for the entire customer base. One could apply Bayesian statistical analysis techniques. The precise method used to generate predictors is not germane to the present invention. The predictors are then used to generate additional product recommendations in a personalized recommendation list 18. which is communicated to the customer 20. Products should be recommended according to whether the predictors predict that the product will be accepted by the customer.

The precise method by which the particular repertoire of recommendations is selected is not specified. One might, for example, take the top N predictions, or one might select a random sample of N from the top M predictions, for some N<M. A straightforward extension of the invention is to offer a tiered incentive structure. A top tier of recommendations are offered with a full money-back guarantee. A second tier of recommendations is offered with a partial refund guarantee. Many other variations are possible.

Over time, as the database gets populated with data, it is expected that product recommendations will converge to a state where recommended products will be accepted with very high probability. In order to seed the process, new products can be “test marketed” by recommending them initially to a small subset of the customer base. This subset can be randomly selected, or, preferably, it can be selected to provide good statistical coverage.

The data on product acceptance and returns from this initial subset is then used to generate predictors for the next round of recommendations, which should have a higher acceptance rate. This process can be repeated, but should converge on the theoretical limit for the product acceptance rate within a small number of rounds. Additional seed data can be generated by offering an incentive for customers who buy a product on their own initiative (that is, without having it recommended to them) to provide feedback on whether or not they liked it.

Turning next to FIG. 2, there is shown a flow chart 30 for general data mining algorithm. In a first step 32, a relationship is defined for every customer (“Cᵢ”) and every product (“Pⱼ”) as R(Cᵢ, Pⱼ) which is an assessment by C of the “quality” of P or the “satisfaction” of C with P. In the next step 34, a correlation (or anti-correlation) is derived based on retention/reurn history of a pair of customers (C₁ and C₂) is computed as V(C₁, C₂).

In a further step 36, for every product Pⱼ that customer Cᵢ has not purchased, a measure of the likelihood that Cᵢ will retain Pⱼ based on the retention/return history of other customers and the similarities/dissimilarities of the purchasing histories of those other customers, is computed as Q(C,P). In this computation, the purchasing histories of those other customers are correlated to the retention/return history of customer Cᵢ.

As a result, a final step 28 generates a list of products corresponding to the highest values of Q as a product list to be recommended to customer Cᵢ. This assures that the products so recommended will have a high probability of acceptance. These recommendations reflect not only the purchasing history of the particular customer, but the purchasing histories of many customers with similar likes and dislikes.

Turning finally to FIG. 3, there is shown a flow diagram of a particular data mining algorithm 40. One definition of the first step 32 of FIG. 2 is expressed in a particular calculation of the function R(C,P). In this first calculation 42, the function R(Cᵢ,Pⱼ) is set=1 if customer Cᵢ has purchased and retained product Pj. The function is set to =−1 if customer Cᵢ has purchased and returned product Pⱼ. The function has a value=0 if customer Cᵢ has not purchased product Pⱼ.

In a next calculating step 44, a value is determined for the correlation function V(C₁, C₂) of step 34 of FIG. 2. This function starts by setting its value to 0. Then, for each product Pⱼ, add the result of R(C₁, Pⱼ)×R(C₂, Pⱼ) to V(C₁, C₂) for products P₁ through P_{z}. The result will be some finite number depending upon the calculated value of each function, reflecting whether Pⱼ was purchased or not and, if purchased, whether it was kept or returned.

The value of Q, which could be considered a predictor of desirability, is computed in a next step 46. Here, for every customer C₁, compute a value of Q(C₁, Pⱼ) through the following steps. Assuming, of course, that C₁ has not yet purchased Pⱼ, that is the function R(C₁,Pⱼ)=0, the function Q(C₁, Pⱼ) is set equal to 0. Then, for every customer Cᵢ, examine the value of V(C₁, Cᵢ). When the correlation function V for a customer pair in which C₁ is one of the pair is greater than 0, the product of V(C₁, C₁) and R(Cᵢ, Pⱼ) is added to the function Q(C₁, Pⱼ). The greater the number of customers that purchased and retained a particular product, the greater the value of Q for that product.

The process step 46 is repeated for a number of products Pⱼ and a Q value can be generated for each such product. The next logical step in the process is a list generating step 48. Here, for each customer Cᵢ, a product list can be generated by looking at the values of Q that were generated in step 46 for that customer. The product with the highest Q value would be placed highest on the list, followed by the remaining Q values for other products. In some embodiments, there would be a minimum Q value, below which a product would not be included on the list. The list, when generated, would provide each customer with a choice of products which were most popular with other consumers whose tastes and likes were deemed to be highly similar.

An additional predictor would be based on an anti-correlation wherein consumers whose tastes and likes were deemed to be highly dissimilar would be considered in creating a list. In this circumstance products that were acquired and then returned by consumers with generally dissimilar tastes would be a good predictor. If a subset of consumers disliked everything a target customer liked, then rejection of a product would strongly suggest that the target customer would be more likely to accept and retain such a product.

As more and more customers are added to the database so that more correlations can be established, and as more and more products are evaluated, eventually products could be recommended with a high expectation of purchase and retention. However, a newly introduced product would probably not be recommended until a reasonable number of purchases had been made, both with and without returns.

Thus there has been described in some detail a method and apparatus for creating a list of recommended products for a target consumer with a high likelihood of acceptance by that consumer. The scope of the invention should be limited only by the breadth of the claims appended below.

1. A method for recommending goods and/or services to target customers based on general customer buying history using an information processing system having means for storing information, the method comprising the steps of:
a) receiving and storing customer information regarding purchase, retention and return of goods and services for a plurality of customers;
b) comparing the stored information of a target customer with the stored information of other customers whose information is stored and correlating the purchase and return history of each target customer with the purchase and return history of other customers to create, for each target customer, a first and second subset of customers with histories similar and dissimilar to that of each target customer, respectively;
c) selecting products and services that:
1) have not yet been purchased by a selected target customer, and
2) have generally been purchased and retained by customers of said first subset;
d) adding the products and services identified in step (c) to a list of recommended products; and
e) transmitting said list of recommended products to said selected target customer, whereby products recommended to each target customer are those retained by customers in said first subset corresponding to that target customer.

2. The method of claim 1, wherein the selecting step includes, for each target customer, selecting products and services that have been purchased and returned by customers in said second subset corresponding that target customer and said adding step includes adding to said list, the products and services purchased and returned by customers of said second subset.

3. The method of claim 1 wherein the purchase and return information and the lists of recommended products and services are communicated via a computer network.

4. The method of claim 2 wherein the purchase and return information and the lists of recommended products and services are communicated via a computer network.

5. The method of claim 1 wherein the network is the Internet.

6. The method of claim 2 wherein the network is the Internet.

7. The method of claim 1 wherein the network is a local area network.

8. The method of claim 2 wherein the network is a local area network.

9. The method of claim 1 wherein the distributed network is a wide area network.

10. The method of claim 2 wherein the distributed network is a wide area network.

11. The method of claim 1, further including the step of:
f.) offering to target customers a financial incentive for purchasing products and services on said list of recommended products, whereby the target customer is induced by the incentive to buy the product.

12. The method of claim 2, further including the step of:
f.) offering to target customers a financial incentive for purchasing products and services on said list of recommended products, whereby the target customer is induced by the incentive to buy the product.

13. The method of claim 111 wherein said financial incentive is a money-back guarantee.

14. The method of claim 12 wherein said financial incentive is a money-back guarantee.

15. The method of claim 1 wherein the measure of quality for the goods and services being provided is at least partially subjective.

16. A system for recommending a selection of goods and services to a target customer which is likely to appeal to the target customer for purchase and retention, the system comprising:
a) data storage means for storing, for each of a plurality of customers, purchase, retention and return history for identifiable goods and services;
b) correlating means, coupled to said data storage means, for determining, for each target customer, the correlation of purchase and return history of said target customer with the purchase and return history of other customers having purchase and return histories stored in said data storage means to create a first subset of customers with similar histories and a second subset of customers with dissimilar histories,
c) product selection means, coupled to said data storage means and said correlating means to create a list of products that
1) have not yet been purchased by a target customer, and
2) have generally been purchased and retained by said first subset of customers corresponding to that target customer; and
d) presentation means for furnishing to each said target customer the list of products created by said product selection means for that target customer.

17. The apparatus of claim 16, above wherein said second subset created by said correlating means includes, for each product purchased and retained by a target customer, customers who have purchased and returned each such product, and whereby said list of products includes products purchased and returned by said second subset of customers.

18. The system of claim 16 further including financial incentive means for inducing a target customer to purchase goods and services on said list of products.

19. The system of claim 17 further including financial incentive means for inducing a target customer to purchase goods and services on said list of products.

20. The system of claim 18 wherein said financial incentive means include means for processing a money-back guarantee upon return of products purchased from the list.

21. The system of claim 19 wherein said financial incentive means include means for processing a money-back guarantee upon return of products purchased from the list.

22. A computer-implemented interactive system for recommending to a target customer a list of goods and services which are likely to appeal to the target customer for purchase and retention, the system comprising:
a. data storage means for storage of customer purchase, retention and return history for identifiable goods and services;
b. correlating means, coupled to said data storage means, for creating, for each target customer, a first subset of customers with similar histories of purchase, retention and return of the same goods and services;
c. data mining means coupled to said data storage means to ascertain, for a product not yet purchased by a target customer, the purchase, retention and return history for that product by said first subset of customers; and
d. compiling means, coupled to said data storage means and said data mining means for creating a list of products not yet purchased by said target customer that have been purchased and retained by said first subset of customers, whereby a list produced by said compiling means can be prepared and transmitted to said target customer as products recommended for purchase.

23. The system of claim 22, wherein said correlating means, creates, for each target customer, a second subset of customers with dissimilar histories of purchase, retention and return of the same goods and services and wherein said data mining means and said compiling means also ascertains for a product not yet purchased by said target customer, a list of products that have been purchased and returned by said second subset of customers to be included in said list transmitted to said target customer.

24. The system of claim 21 further including financial incentive means for inducing a target customer to purchase goods and services on said list of products.

25. The system of claim 22 further including financial incentive means for inducing a target customer to purchase goods and services on said list of products.

26. The system of claim 24 wherein said financial incentive means include means for processing a money-back guarantee upon return of products purchased from the list.

27. The system of claim 25 wherein said financial incentive means include means for processing a money-back guarantee upon return of products purchased from the list.
